(19) United States
(12) Patent Application Publication
(10) Pub. No.: US 2023/0247968 A1
(43) Pub. Date: Aug. 10, 2023

(54) Pet Harness with Weighted Thermal Insert

(71) Applicants: Pearl Maremont, Pacific Palisades, CA (US); Lindsey Michelle Buchanan, Los Angeles, CA (US)

(72) Inventors: Pearl Maremont, Pacific Palisades, CA (US); Lindsey Michelle Buchanan, Los Angeles, CA (US)

(21) Appl. No.: 18/302,704

(22) Filed: Apr. 18, 2023

Related U.S. Application Data
(63) Continuation-in-part of application No. 17/382,230, filed on Jul. 21, 2021, now abandoned.
(60) Provisional application No. 63/054,711, filed on Jul. 21, 2020.

(51) Int. Cl. A01K 27/00; A01K 13/00

(52) U.S. Cl. CPC A01K 27/002; A01K 27/008; A01K 13/006

(57) ABSTRACT

A pet harness with a weighted thermal insert is an apparatus that can be comfortably and securely worn by a pet to provide comfort and various therapeutic benefits. The apparatus may include a back-bracing pad, a neck-bracing strap, a girth-bracing band, and at least one weighted thermal insert. The back-bracing pad corresponds to the portion covering the pet's back. The neck-bracing strap secures the apparatus to the pet's neck to prevent the apparatus from getting loose around the pet's neck. The girth-bracing band keeps the back-bracing pad securely positioned against the pet's back while the pet is moving. The at least one weighted thermal insert helps regulate the temperature of the pet's body when the pet is exposed to different weather conditions. The at least one weighted thermal insert also weighs down the pet's body to calm the pet down and to prevent the pet from getting anxious.

The current application is a continuation-in-part (CIP) application of a U.S. non-provisional application Ser. No. 17/382,230 filed on Jul. 21, 2021. The U.S. non-provisional application Ser. No. 17/382,230 claims a priority to the U.S. provisional patent application Ser. No. 63/054,711 filed on Jul. 21, 2020.

### FIELD OF THE INVENTION

The present invention relates generally to pet accessories and pet therapeutical devices. More specifically, the present invention provides a dual-purpose pet harness capable of alleviating pain, anxiety, and discomfort in pets by utilizing a weighted thermal insert to provide sensory and tactile stimulation to convey a sense of comfort and calm the nervous system.

### BACKGROUND OF THE INVENTION

Nowadays, pet owners are aware that their furry friends experience a range of emotions, sensory issues, and physical discomforts. In addition, anxiety is a common issue among pets today. Touch therapy, weighted blankets, and compression wraps have all been proven effective in reducing anxiety levels in dogs. However, there has not been a therapeutic weighted dog vest or harness with a compression girth wrap designed to help alleviate these issues in dogs. Furthermore, certain breeds of dogs are more susceptible to heat exhaustion and hypothermia caused by extreme weather conditions. In fact, many of the same breeds are also prone to obesity and, therefore, arthritis and inflammation. French bulldogs and English bulldogs, for example, are at higher risk of heatstroke and hypothermia due to their short snouts and stocky builds, as well as joint problems due to their weight. Therefore, there is a need for a therapeutic weighted dog vest or harness with a compression girth wrap that also provides cooling, warming, calming, and aromatherapy benefits to the dog.

An objective of the present invention is to address these issues by providing a dual-purpose pet harness with a weighted thermal insert that provides sensory comfort to the pet wearing the pet harness. The present invention is designed to alleviate anxiety and discomfort in pets caused by fear of abandonment, sensory or social issues, pain & inflammation, heat exhaustion, and hypothermia. Another objective of the present invention is to provide a pet harness with a weighted thermal insert that is easy to put on the pet and enables size adjustment to accommodate the size of the pet. Another objective of the present invention is to provide a weighted thermal insert with a low thermal conductivity that keeps the pet comfortable while wearing the pet harness. The weighted thermal insert can be cooled down or warmed up depending on the weather conditions to keep the pet wearing the pet harness comfortable. Additional features and benefits are further discussed in the sections below.

### SUMMARY OF THE INVENTION

The present invention provides a pet harness with a weighted thermal insert. The present invention is a novel pet harness designed to provide the most comfort and protection to the pet wearing the present invention. The present invention combines the benefits of touch therapy, weighted blankets, and compression wraps by utilizing a weighted thermal insert capable of stimulating senses and calming the nervous system. The weighted thermal insert easily conforms to the pet's upper-mid back and weighs the pet's back down evenly to provide a calming and hugging sensation, while the girth wrap provides compression and security. Additionally, the cooling and warming effects provided by the weighted thermal insert help to regulate body temperature and heal inflammation via hot/cold compression.

The pet harness is preferably a multilayered flexible structure that includes an outer layer made of a material that is flexible and durable, such as laminated neoprene. The pet harness also includes an inner layer made of protective material, such as cooling or wicking fabric. The weighted thermal insert can be made from different materials that enable the weighted thermal insert to be warmed up, cooled down, or provide other therapeutical benefits such as aromatherapy. The weighted thermal insert can be made from gel material that can be repeatedly refrigerated to cool down the pet wearing the present invention. In addition, the weighted thermal insert can be made from clay beads or appropriate gel beads that can be heated up to keep the pet warm while wearing the present invention. Further, the weighted thermal insert can be designed to provide aromatherapy to relax the pet and provide other therapeutic benefits.

The present invention can also include various features that facilitate the control of the pet wearing the present invention. For example, durable fasteners are provided that can be used to adjust the pet harness so that the pet is securely restrained by the pet harness. In addition, the present invention can include safety features such as reflective lining that increases the visibility of the pet at night. Further, the present invention can include means to secure a leash to the pet harness or for the pet owner to directly handle the pet using the pet harness. In addition, the present invention can be provided in different sizes to accommodate different pet sizes including, but not limited to, an extra-extra small size, an extra small size, a small size, a medium size, and a large size. Additional features can be included that increase the functionality of the present invention.

### BRIEF DESCRIPTION OF THE DRAWINGS

FIG. 1 is a top front perspective view of the present invention, wherein the present invention is shown worn by a dog.

FIG. 2 is a top front perspective view of the present invention.

FIG. 3 is a bottom rear perspective view of the present invention.

FIG. 4 is a front view of the present invention, wherein a weighted thermal insert is shown being inserted into an insert pocket of the present invention.

FIG. 5 is a rear view of the present invention, wherein the weighted thermal insert is shown positioned within the insert pocket of the present invention.

FIG. 6 is a front schematic view of the present invention.

FIG. 7 is a rear schematic view of the present invention.

FIG. 8 is a side schematic view of the insert pocket of the present invention, wherein the weighted thermal insert is shown within the insert pocket.

FIG. 9 is a side schematic view of the weighted thermal insert of the present invention.

### DETAIL DESCRIPTIONS OF THE INVENTION

All illustrations of the drawings are for the purpose of describing selected versions of the present invention and are not intended to limit the scope of the present invention.

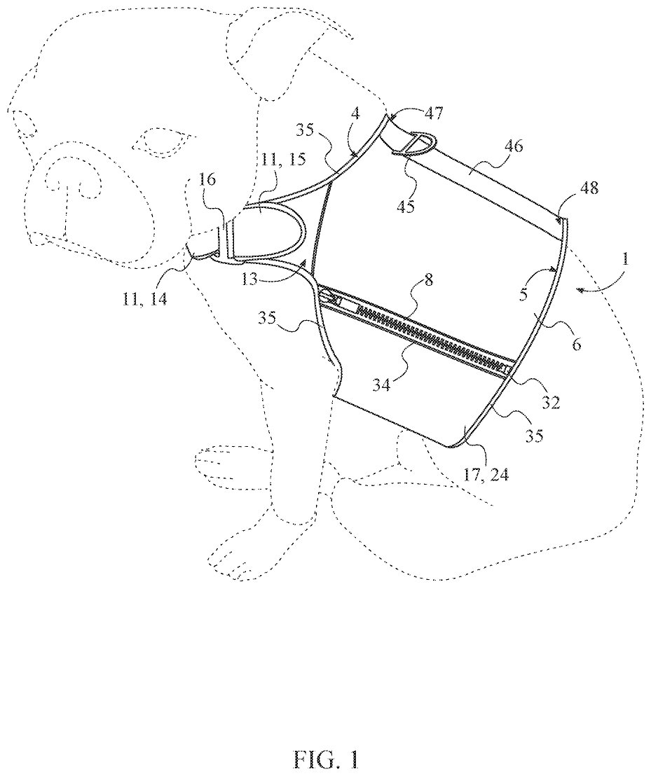

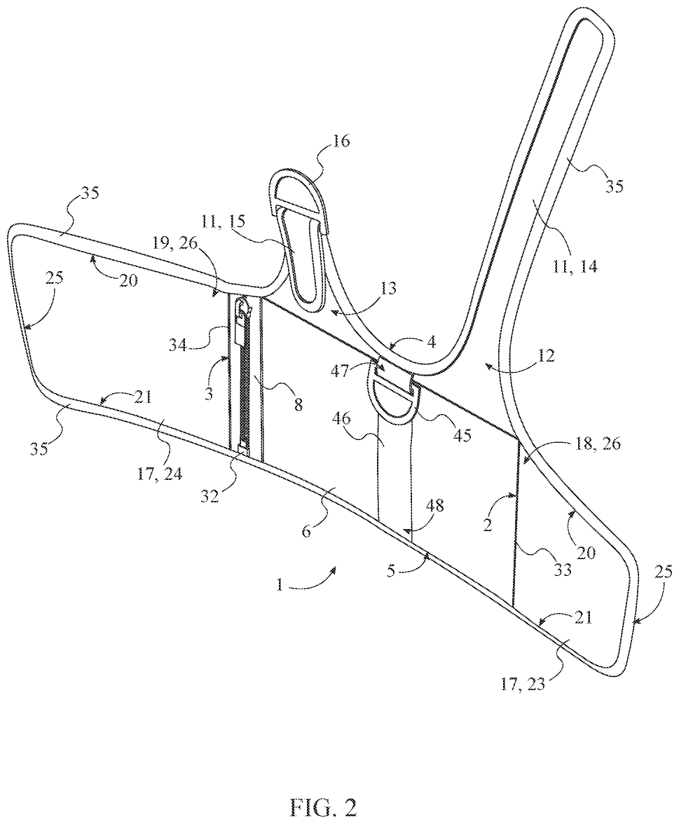

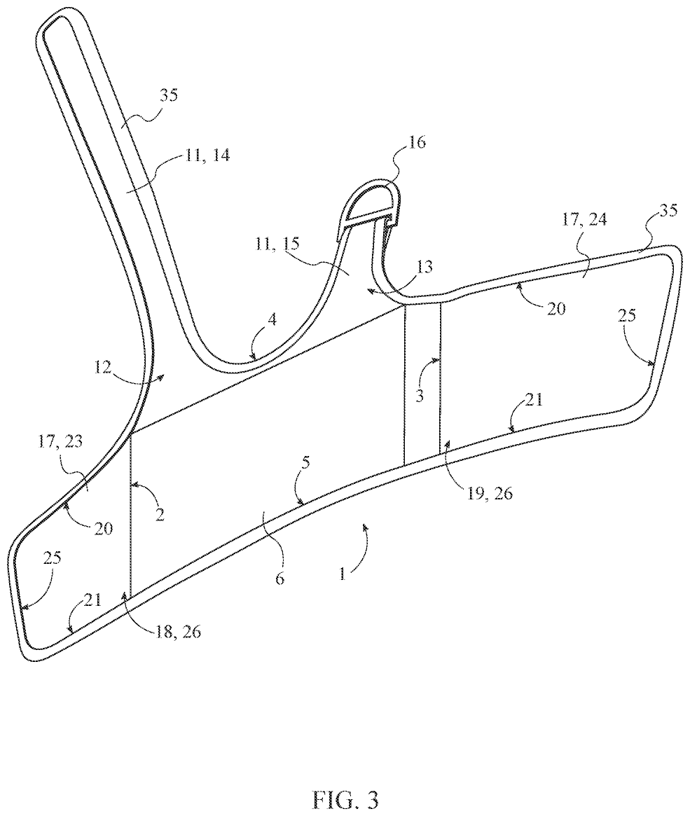

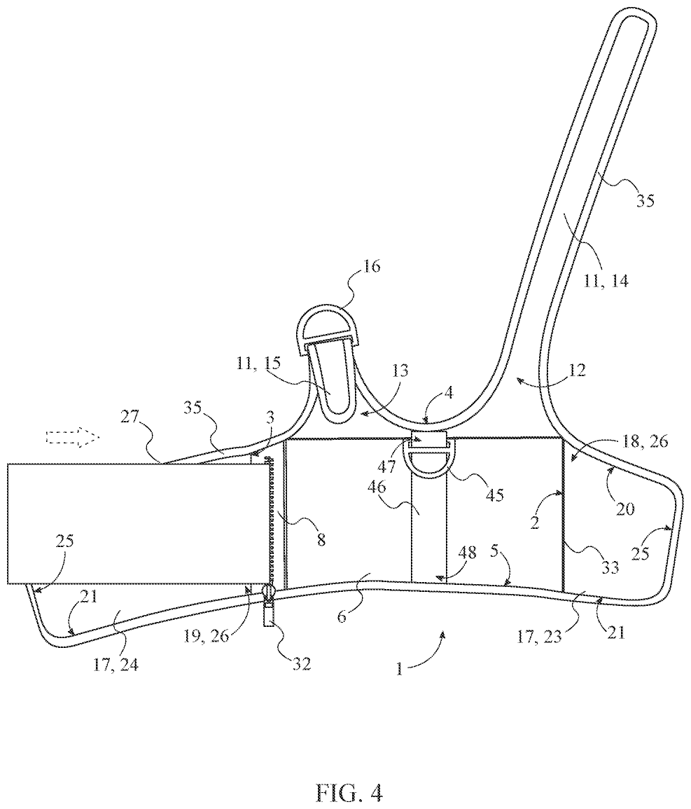

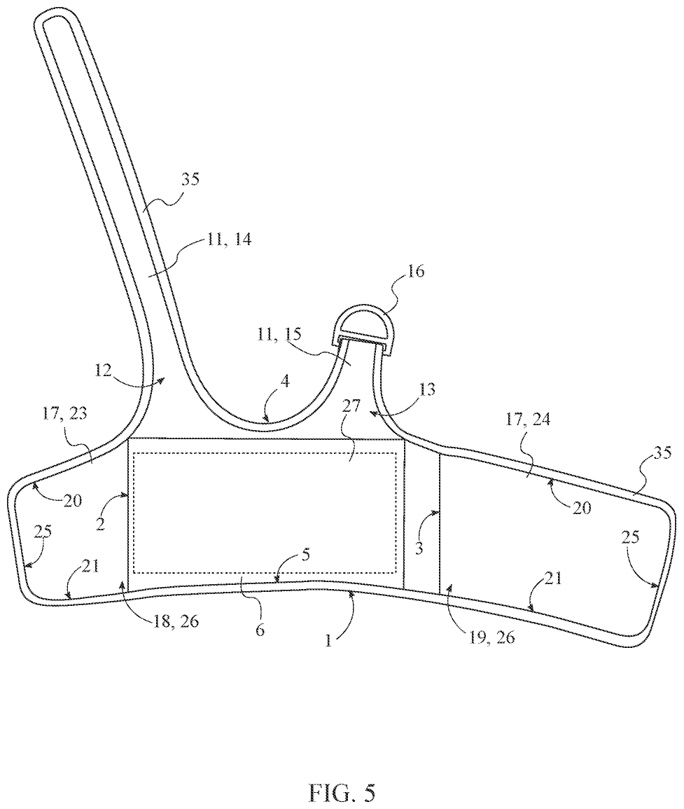

The present invention is a pet harness with a weighted thermal insert that can be comfortably and securely worn by a pet to provide comfort and various therapeutic benefits to the pet. As can be seen in FIGS. 1 through 5, the present invention comprises a back-bracing pad 1, a neck-bracing strap 11, a girth-bracing band 17, and at least one weighted thermal insert 27. The back-bracing pad 1 corresponds to the portion of the present invention covering the pet's back. The neck-bracing strap 11 secures the present invention to the pet's neck to prevent the present invention from getting loose around the pet's neck. The girth-bracing band 17 keeps the back-bracing pad 1 positioned against the pet's back while also securing the present invention to the pet's body. The at least one weighted thermal insert 27 enables the present invention to maintain the pet's body cool or warm depending on the weather conditions. The at least weighted thermal insert 27 also weighs down the back-bracing pad 1 against the pet's body to help calm the pet down and to prevent the pet from getting anxious. Together, these components form a single flexible structure that comfortably wraps around the pet's body to provide relaxation and comfort to the pet as well as other therapeutic benefits including, but not limited to, hot and/or cold compression therapy for pain, inflammation, anxiety, discomfort, etc.

The general configuration of the aforementioned components enables pet owners to securely restrain pets while keeping the pet comfortable and relaxed. As can be seen in FIGS. 1 through 5, the back-bracing pad 1 is designed to conform to the back of the pet's body and to keep the at least one weighted thermal insert 27 close to the pet's body. The back-bracing pad 1 comprises a first lateral edge 2, a second lateral edge 3, a cranial edge 4, a caudal edge 5, and an insert pocket 6. The first lateral edge 2 and the second lateral edge 3 preferably correspond to the shorter side edges of the back-bracing pad 1. The cranial edge 4 preferably corresponds to the edge that is positioned adjacent to the pet's neck, while the caudal edge 5 corresponds to the edge that is positioned adjacent to the pet's rear. The insert pocket 6 enables the removable mounting of the at least one weighted thermal insert 27 into the back-bracing pad 1. Further, the neck-bracing strap 11 is an elongated strap structure that comfortably fits around the pet's neck. Accordingly, the neck-bracing strap 11 comprises a first strap end 12 and a second strap end 13 corresponding to the terminal strap ends of the neck-bracing strap 11. Similarly, the girth-bracing band 17 is an elongated, wide band structure that comfortably fits around the pet's abdomen. The girth-bracing band 17 is also preferably designed to be a stretchable band structure that enables the adjustment of levels of compression of the pet's body. Accordingly, the girth-bracing band 17 comprises a first band end 18 and a second band end 19 corresponding to the terminal ends of the girth-bracing band 17.

The present invention is preferably assembled as follows. As can be seen in FIGS. 1 through 5, the first lateral edge 2 and the second lateral edge 3 are positioned opposite to each other across the back-bracing pad 1 due to the width of the back-bracing pad 1. Similarly, the cranial edge 4 and the caudal edge 5 are positioned opposite to each other across the back-bracing pad 1 due to the length of the back-bracing pad 1. Further, the cranial edge 4 and the caudal edge 5 are positioned in between the first lateral edge 2 and the second lateral edge 3 to form an overall elongated rectangular structure. Further, the insert pocket 6 is integrated into the back-bracing pad 1 to receive the at least one weighted thermal insert 27. The first strap end 12 and the second strap end 13 are positioned offset from each other to accommodate the pet's neck. The first strap end 12 and the second strap end 13 are also connected adjacent to the cranial edge 4 to secure the back-bracing pad 1 to the pet's neck. Furthermore, the first band end 18 is connected adjacent to the first lateral edge 2 while the second band end 19 is attached adjacent to the second lateral edge 3. This way, the girth-bracing band 17 can be wrapped around the pet's abdomen to secure the back-bracing pad 1 to the pet's body. Further, the at least one weighted thermal insert 27 is positioned within the insert pocket 6 to maintain the at least one weighted thermal insert 27 close to the pet's body. The insert pocket 6 is preferably centrally integrated into the back-bracing pad 1 so that the inserted at least one weighted thermal insert 27 is evenly distributed across the pet's back.

The at least one weighted thermal insert 27 serves to provide comfort to the pet under different weather conditions. Due to the heat exchange that can occur between the at least one weighted thermal insert 27 and the surroundings, the present invention is designed to protect the pet from the effects of the heat exchange. For example, if the at least one weighted thermal insert 27 is designed to cool down the pet during a hot day, moisture can accumulate around the at least one weighted thermal insert 27 that can get the pet's fur wet. As can be seen in FIGS. 1 through 5, 8, and 9, to protect the pet from the effects that may result from the heat exchange, the present invention may further comprise a thermally-insulating lining 31. The thermally-insulating lining 31 is designed to protect the pet from the effects of the heat exchange, such as moisture that can wet the pet's fur. To accommodate the thermally-insulating lining 31, the insert pocket 6 may comprise an inner pocket surface 7 corresponding to the surface that is in contact with the at least one weighted thermal insert 27. The thermally-insulating lining 31 is superimposed across the inner pocket surface 7 so that the entire inner pocket surface 7 is covered with the thermally-insulating lining 31. In some embodiments, the thermally-insulating lining 31 can be made of mylar film material. The mylar film material can be sewn onto the inner pocket surface 7 to serve as a heat barrier. In addition, the mylar film material can also serve to prolong the thermal properties of the at least one weighted thermal insert 27, such as keeping the at least one weighted thermal insert 27 cool longer during hot days. However, other fabrics can be used for the thermally-insulating lining 31 or other insulation mechanisms can be used.

The insert pocket 6 is designed to securely retain the at least one weighted thermal insert 27 while enabling the pet owner to remove the at least one weighted thermal insert 27 from the back-bracing pad 1. As can be seen in FIGS. 1 through 5, the present invention may further comprise a pocket fastener 32. The insert pocket 6 may further comprise a pocket opening 8 that can be selectively opened using the pocket fastener 32 that enables the removal of the at least one weighted thermal insert 27. Accordingly, the pocket opening 8 traverses through the back-bracing pad 1 and into the insert pocket 6 to enable the insertion of the at least one weighted thermal insert 27 into the insert pocket 6. Further, the pocket fastener 32 is connected along the pocket opening 8 so that the pocket opening 8 can be selectively opened or closed using the pocket fastener 32. The pocket fastener 32 is preferably an insulated zipper that prevents any water from entering the insert pocket 6, prevents any leakage from the insert pocket 6, and/or prevents anything from falling out of the insert pocket 6 when the dog is playing or moving around. The insulated zipper keeps the at least one weighted thermal insert 27 the most secure and facilitates the removal of the at least one weighted thermal insert 27 while the rest of the present invention remains on the pet. In other embodiments, the pocket fastener 32 can be a hook and loop fastener that is flexible yet durable to endure the movement of the pet. However, other types of fasteners can be utilized for pocket fasteners including but not limited to zippers, snaps, or buttons.

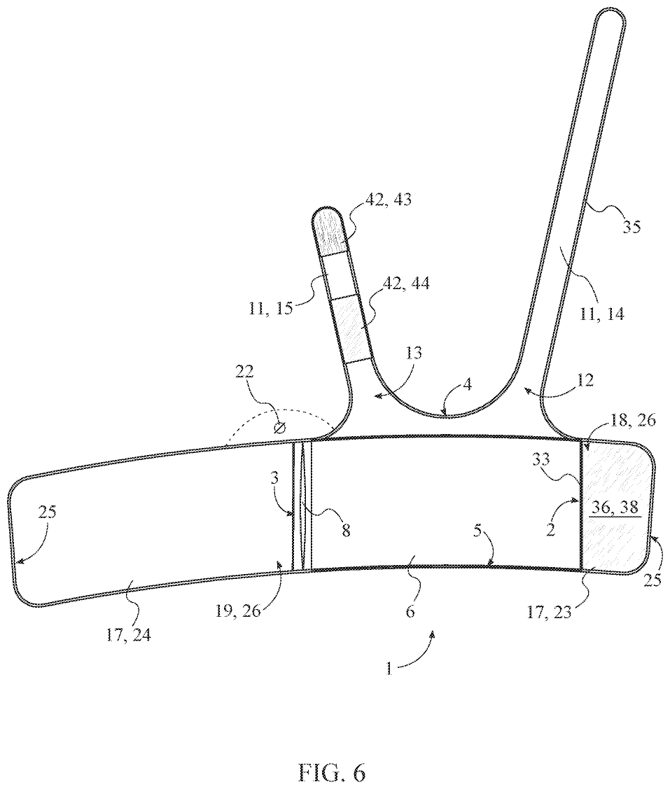

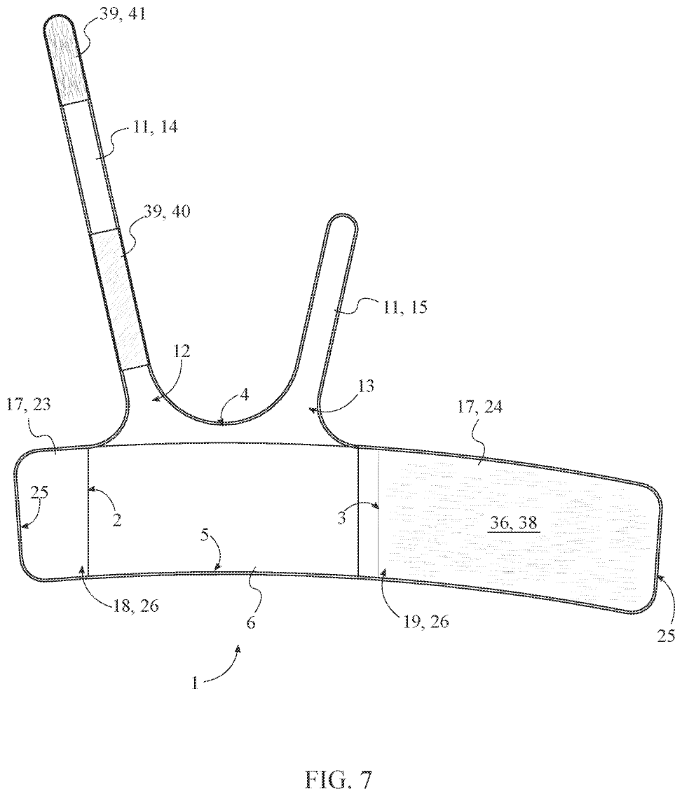

As can be seen in FIGS. 6 and 7, to make the present invention as comfortable as possible for the pet while also safely restraining or tethering the pet, the back-bracing pad 1, the neck-bracing strap 11, and the girth-bracing band 17 can be made of laminated neoprene. In some embodiments, the laminated neoprene can be elastic brushed loop neoprene that has hook and loop fastening capabilities so that the laminated neoprene can be used for fastening without additional fasteners. For example, the back-bracing pad 1, the neck-bracing strap 11, and the girth-bracing band 17 can be made of one-to-two-millimeter hook receptive laminated neoprene. In other embodiments, other flexible and durable materials can be utilized.

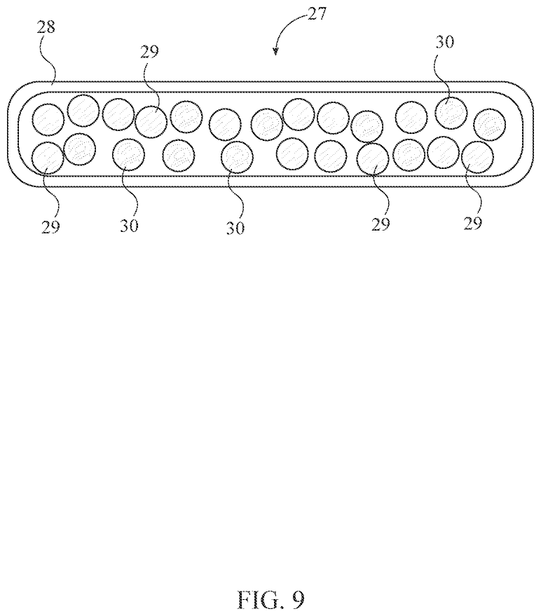

As previously discussed, the at least one weighted thermal insert 27 can serve to maintain the pet comfortable during different weather conditions as well as to provide various therapeutic benefits. As can be seen in FIG. 9, the at least one weighted thermal insert 27 may comprise an insert fabric enclosure 28 and a plurality of heat-sinking beads 29. The insert fabric enclosure 28 retains the plurality of heat-sinking beads 29 together. The plurality of heat-sinking beads 29 can be refrigerated or heated up in order to cool down or warm up the pet, respectively. Accordingly, the plurality of heat-sinking beads 29 is positioned within the insert fabric enclosure 28 so that the plurality of heat-sinking beads 29 is protected by the insert fabric enclosure 28. In addition, the plurality of heat-sinking beads 29 is evenly distributed throughout the insert fabric enclosure 28. This way, when the at least one weighted thermal insert 27 is positioned within the insert pocket 6, the insert fabric enclosure 28 can conform to the pet's body while ensuring that the plurality of heat-sinking beads 29 cover the largest surface area on the pet's body. In some embodiments, the insert fabric enclosure 28 is a made of extra-thick nylon material with super-durable double-seam construction to prevent leaking of the heat-sinking beads while enabling the cleaning of the insert fabric enclosure 28. In addition, the plurality of heat-sinking beads 29 can be weighted natural clay beads made from all-natural ceramic and non-toxic oils. Alternatively, the plurality of heat-sinking beads 29 can be silica beads. In other embodiments, different thermal materials can be utilized for the plurality of heat-sinking beads 29.

Further, the at least one weighted thermal insert 27 can be designed to provide aromatherapy benefits to the pet. As can be seen in FIG. 9, the at least one weighted thermal insert 27 may further comprise a plurality of aromatherapeutic beads 30. The plurality of aromatherapeutic beads 30 is designed to release various therapeutic aromas onto the pet. Accordingly, the plurality of aromatherapeutic beads 30 is positioned within the insert fabric enclosure 28 like the plurality of heat-sinking beads 29. In addition, the plurality of aromatherapeutic beads 30 is heterogeneously mixed into the plurality of heat-sinking beads 29. This way, when the at least one weighted thermal insert 27 is positioned within the insert pocket 6, aromas are evenly released onto the pet while also maintaining an even heat exchange around the pet's body. In some embodiments, the clay beads can be applied with aromatherapy non-toxic oils. The clay beads can also be filled with natural scents to provide olfactory stimulation and relaxation. In other embodiments, different aromatherapeutic devices or appropriate therapeutic attachments can be utilized that can be attached to the present invention.

In addition to maintaining the pet comfortable and calm, the present invention can also include various safety features that help keep the pet and the pet owner safe. For example, the present invention can include reflective materials to enable the present invention to be illuminated in low-light conditions. In some embodiments, the present invention may further comprise a first piece of light-reflective stitching 33, a second piece of light-reflective stitching 34, and a third piece of light-reflective stitching 35, as can be seen in FIGS. 1 through 5. The light-reflective stitching serves to reflect light from light sources adjacent to the present invention so that the pet can be visible at night or in low-light conditions. Accordingly, the first band end 18 is connected adjacent to the first lateral edge 2 by the first piece of light-reflective stitching 33. In addition, the second band end 19 is attached adjacent to the second lateral edge 3 by the second piece of light-reflective stitching 34. Further, the third piece of light-reflective stitching 35 is perimetrically integrated into the neck-bracing strap 11, the girth-bracing band 17, and the back-bracing pad 1. This way, the present invention can be visible at night or in low-light conditions without altering the design of the present invention or reducing the comfort of the pet.

To make the present invention fit the anatomy of the pet, the girth-bracing band 17 is designed to accommodate the different anatomical features of the pet. As can be seen in FIGS. 1 through 5, the girth-bracing band 17 may further comprise a first lengthwise edge 20 and a second lengthwise edge 21 that preferably correspond to the long edges of the girth-bracing band 17. In addition, the first lengthwise edge 20 is preferably a convex edge, while the second lengthwise edge 21 is a concave edge. The concave edge accommodates the various anatomical features around the pet's abdomen, such as the reproductive organs of the pet. Accordingly, the first lengthwise edge 20 is oriented at an obtuse angle 22 with the cranial edge 4 and coincident with the cranial edge 4 to enable the seamless transition from the cranial edge 4 to the first lengthwise edge 20. In addition, the first lengthwise edge 20 is also oriented away from the neck-bracing strap 11 so that the girth-bracing band 17 better fits around the pet's belly. On the other hand, the second lengthwise edge 21 is positioned coincident with the caudal edge 5 to enable the girth-bracing band 17 to be wrapped around the pet's abdomen without causing discomfort to the pet when wearing the present invention.

Furthermore, to enable the girth-bracing band 17 to be releasably fastened on the side of the pet's abdomen, the present invention may further comprise a band fastener 36. As can be seen in FIGS. 1 through 7, the band fastener 36 enables the girth-bracing band 17 to be releasably fastened without much hassle. To accommodate the band fastener 36, the girth-bracing band 17 may further comprise a first band section 23 and a second band section 24 corresponding to two separate sections of the girth-bracing band 17 that can be selectively fastened to each other using the band fastener 36. In addition, the first band section 23 and the second band section 24 may each comprise a free section end 25 and a fixed section end 26. The free section end 25 preferably corresponds to the section end that is engaged with the band fastener 36, while the fixed section end 26 corresponds to the section end that is secured to the back-bracing pad 1. Accordingly, the fixed section end 26 of the first band section 23 is positioned coincident to the first band end 18, while the fixed section end 26 of the second band section 24 is positioned coincident to the second band end 19. This way, the free section end 25 of the first band section 23 and the free section end 25 of the second band section 24 are left loose to be selectively fastened to each other. Then, to fasten the first band section 23 to the second band section 24, the free section end 25 of the first band section 23 is connected to the free section end 25 of the second band section 24 by the band fastener 36. Furthermore, the second band section 24 is preferably longer than the first band section 23 so that when the two band sections are fastened together using the band fastener 36, the two band sections are fastened on the side of the pet. This way, the girth-bracing band 17 can be safely and comfortably adjusted to compress the pet's body as desired. The second band section 24 may also be longer than the back-bracing pad 1.

In some embodiments, the band fastener 36 is preferably a two-piece fastener that can be manually engaged or disengaged. For example, the band fastener 36 may be a hook and loop fastener. So, the band fastener 36 may comprise a first band fastener piece 37 and a second band fastener piece 38, as can be seen in FIGS. 1 through 7. The first band fastener piece 37 can be the loop portion of the fastener, while the second band fastener piece 38 can be the hook portion of the fastener. Accordingly, the first band fastener piece 37 is mounted onto the first band section 23, adjacent to the free section end 25 of the first band section 23, to secure the first band fastener piece 37 to the first band section 23. Similarly, the second band fastener piece 38 is mounted onto the second band section 24, adjacent to the free section end 25 of the second band section 24, to secure the second band fastener piece 38 to the second band section 24. Then, to fasten the first band section 23 to the second band section 24, the first band fastener piece 37 is engaged with the second band fastener piece 38. In other embodiments, different types of fasteners can be utilized.

Like the girth-bracing band 17, the neck-bracing strap 11 can also be releasably fastened to facilitate the attachment and removal of the present invention. So, the neck-bracing strap 11 may further comprise a first strap member 14, a second strap member 15, and a strap ring 16, as can be seen in FIGS. 1 through 7. The first strap member 14 is preferably the elongated member that enables the adjustment of the working length of the neck-bracing strap 11. The second strap member 15 serves to retain the strap ring 16 which facilitates the adjustment of the working length of the neck-bracing strap 11. Accordingly, the first strap member 14 is positioned coincident to the first strap end 12, while the second strap member 15 is positioned coincident to the second strap end 13. This provides enough space between the first strap member 14 and the second strap member 15 to accommodate the pet's neck. Moreover, the second strap member 15 is looped through the strap ring 16, offset from the second strap end 13, so that the strap ring 16 is kept separate from the back-bracing pad 1. Further, the first strap member 14 is looped through the strap ring 16, offset from the first strap end 12, to enable the user to adjust the working length of the neck-bracing strap 11 around the pet's neck. Furthermore, the first strap member 14 is preferably longer than the second strap member 15. The two strap members may have the same width.

Further, to lock a desired working length of the neck-bracing strap 11, the present invention may further comprise a first strap fastener 39. As can be seen in FIGS. 1 through 7, the first strap fastener 39 facilitates the length adjustment of the neck-bracing strap 11 to accommodate the pet's neck by locking the desired working length of the neck-bracing strap 11. The first strap fastener 39 can be any two-piece fastener that can be releasably fastened, such as a hook and loop fastener. So, the first strap fastener 39 may comprise a first proximal strap fastener piece 40 and a first distal strap fastener piece 41. The first proximal strap fastener piece 40 can be the loop portion of the fastener, while the first distal strap fastener piece 41 can be the hook portion of the fastener. Accordingly, the first proximal strap fastener piece 40 is mounted onto the first strap member 14, adjacent to the first strap end 12, to secure the first proximal strap fastener piece 40 to the first strap member 14. Likewise, the first distal strap fastener piece 41 is mounted onto the first strap member 14, offset from the first strap end 12, to secure the first distal strap fastener piece 41 to the first strap member 14. Then, to fasten the neck-bracing strap 11 around the pet's neck, the first distal strap fastener piece 41 is engaged with the first proximal strap fastener piece 40. This enables the pet owner to adjust the working length of the neck-bracing strap 11 by securing the first distal strap fastener piece 41 at different positions along the first proximal strap fastener piece 40. In other embodiments, the first strap fastener 39 can be replaced with different types of fasteners that do not require the first strap member 14 to be looped through the strap ring 16.

Further, to further facilitate the adjustment of the neck-bracing strap 11 around the pet's neck, the present invention may further comprise a second strap fastener 42. As can be seen in FIGS. 1 through 7, the second strap fastener 42 facilitates the length adjustment of the working length of the second strap member 15 to accommodate the pet's neck. The second strap fastener 42 can also be any two-piece fastener that can be releasably fastened, such as a hook and loop fastener. So, the second strap fastener 42 may comprise a second proximal strap fastener piece 43 and a second distal strap fastener piece 44. The second proximal strap fastener piece 43 can be the loop portion of the fastener, while the second distal strap fastener piece 44 can be the hook portion of the fastener. Accordingly, the second proximal strap fastener piece 43 is mounted onto the second strap member 15, adjacent to the second strap end 13, to secure the second proximal strap fastener piece 43 to the second strap member 15. Likewise, the second distal strap fastener piece 44 is mounted onto the second strap member 15, offset from the second strap end 13, to secure the second distal strap fastener piece 44 to the second strap member 15. Then, to adjust the second strap member 15, the second distal strap fastener piece 44 is engaged with the second proximal strap fastener piece 43. This enables the pet owner to adjust the working length of the second strap member 15 by securing the second distal strap fastener piece 44 at different positions along the second proximal strap fastener piece 43. In other embodiments, the second strap fastener 42 can be replaced with different fasteners that do not require the second strap member 15 to be looped through the strap ring 16.

Further, to enable the present invention to be tethered to a leash or similar control device that lets the pet owner control the movement of the pet, the present invention may further comprise at least one leash-attachment eyelet 45. As can be seen in FIGS. 1 through 5, the at least one leash-attachment eyelet 45 is designed to receive the hook of a leash to tether the present invention to the handle of the leash. To do so, the at least one leash-attachment eyelet 45 is positioned adjacent to the cranial edge 4 so that the pet is pulled from the neck using the leash. The at least one leash-attachment eyelet 45 is also centrally positioned along the cranial edge 4 to prevent the leash from twisting the present invention around the pet's body. Further, the at least one leash-attachment eyelet is externally mounted onto the back-bracing pad 1 to secure the at least one leash-attachment eyelet 45 to the back-bracing pad 1. In other embodiments, the present invention can utilize different mechanisms to enable the pet owner to secure a leash to the present invention.

To enable the pet owner to directly handle the pet from the present invention, the present invention may further comprise a handle strap 46. As can be seen in FIGS. 1 through 5, the handle strap 46 enables the pet owner to directly handle the pet if necessary. The handle strap 46 is a short strap large enough to accommodate the hand of the pet owner. Accordingly, the handle strap 46 may comprise a first handle end 47 and a second handle end 48 corresponding to the terminal ends of the handle strap 46. The handle strap 46 is preferably looped through the at least one leash-attachment eyelet 45 so that the at least one leash-attachment eyelet 45 is secured to the handle strap 46. The first handle end 47 is connected onto the back-bracing pad 1, adjacent to the cranial edge 4, to secure the handle strap 46 close to the cranial edge 4. In addition, the second handle end 48 is connected onto the back-bracing pad 1, adjacent to the caudal edge 5, to also secure the handle strap 46 close to the caudal edge 5. This way, the pet owner can have a secure hold of the pet wearing the present invention.

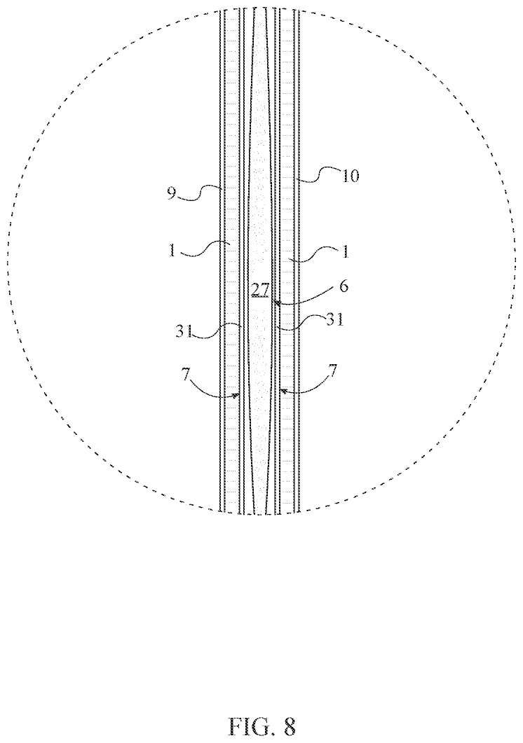

To further improve the pet's comfort when wearing the present invention, the back-bracing pad 1 is designed to make the heat transfer between the pet's body and the at least one weighted thermal insert 27 as comfortable as possible. As can be seen in FIG. 8, the back-bracing pad 1 may further comprise a pad outer layer 9 and a pad inner layer 10. The pad outer layer 9 is preferably a thermal-insulative fabric to insulate the at least one weighted thermal insert 27 from the surrounding weather conditions. This enables the at least one weighted thermal insert 27 warm or cold for longer. On the other hand, the pad inner layer 10 is preferably a moisture-wicking fabric designed to soak up any moisture or sweat that may result from the heat transfer between the at least one weighted thermal insert 27 and the pet's body. Accordingly, the pad outer layer 9 is coextensive with the pad inner layer 10. In addition, the pad outer layer 9 is perimetrically connected to the pad inner layer 10. So, the pad outer layer 9 and the pad inner layer 10 form a uniform pad structure. Furthermore, the insert pocket 6 is integrated in between the pad outer layer 9 and the pad inner layer 10 to keep the at least one weighted thermal insert 27 within the back-bracing pad 1. In other embodiments, the back-bracing pad 1 may include additional layers made from different materials that increase the comfort to the pet while wearing the present invention.

In an exemplary embodiment, the pet owner refrigerates or heats up the at least one weighted thermal insert 27 according to the weather conditions. Once the at least one weighted thermal insert 27 reaches the desired temperature, the pet owner can place the at least one weighted thermal insert 27 inside the insert pocket 6. Then, the pet owner places the back-bracing pad 1 onto the pet's back, aligning the cranial edge 4 with the pet's neck. Then, the pet owner can either fasten the neck-bracing strap 11 or the girth-bracing band 17. The pet owner can fasten the neck-bracing strap 11 by first looping the first strap member 14 through the strap ring 16 and fastening the first strap member 14 in place using the first strap fastener 39. The user can further adjust the neck-bracing strap 11 by adjusting the working length of the second strap member 15 using the second strap fastener 42. The pet owner can also fasten the girth-bracing band 17 by first wrapping the second band section 24 under the pet's abdomen, and then fastening the second band section 24 to the first band section 23 using the band fastener 36. Finally, the pet owner attaches a leash to the at least one leash-attachment eyelet 45 to control the pet. The user is then ready to take the pet for a walk. The pet remains comfortable and calm due to the at least one weighted thermal insert 27 weighing down the pet's body and regulating the pet's body temperature. When finished, the pet owner can easily remove the present invention from the pet's body by releasing both the first strap fastener 39 and the band fastener 36.

Although the invention has been explained in relation to its preferred embodiment, it is to be understood that many other possible modifications and variations can be made without departing from the spirit and scope of the invention as hereinafter claimed.

What is claimed is:

1. A pet harness with a weighted thermal insert comprising:
a back-bracing pad;
a neck-bracing strap;
a girth-bracing band;
at least one weighted thermal insert;
the back-bracing pad comprising a first lateral edge, a second lateral edge, a cranial edge, a caudal edge, and an insert pocket;
the neck-bracing strap comprising a first strap end and a second strap end;
the girth-bracing band comprising a first band end and a second band end;
the first lateral edge and the second lateral edge being positioned opposite to each other across the back-bracing pad;
the cranial edge and the caudal edge being positioned opposite to each other across the back-bracing pad;
the cranial edge and the caudal edge being positioned in between the first lateral edge and the second lateral edge;
the insert pocket being integrated into the back-bracing pad;
the first strap end and the second strap end being positioned offset from each other;
the first strap end and the second strap end being connected adjacent to the cranial edge;
the girth-bracing band being oriented away from the cranial edge;
the first band end being connected adjacent to the first lateral edge;
the second band end being attached adjacent to the second lateral edge; and
the at least one weighted thermal insert being positioned within the insert pocket.

2. The pet harness with a weighted thermal insert as claimed in claim 1 comprising:
a thermally-insulating lining;
the insert pocket comprising an inner pocket surface; and
the thermally-insulating lining being superimposed across the inner pocket surface.

3. The pet harness with a weighted thermal insert as claimed in claim 2, wherein the thermally-insulating lining is made of mylar film material.

4. The pet harness with a weighted thermal insert as claimed in claim 1 comprising:
a pocket fastener;
the insert pocket further comprising a pocket opening;
the pocket opening traversing through the back-bracing pad and into the insert pocket; and
the pocket fastener being connected along the pocket opening.

5. The pet harness with a weighted thermal insert as claimed in claim 4, wherein the pocket fastener is an insulated zipper.

6. The pet harness with a weighted thermal insert as claimed in claim 1, wherein the back-bracing pad, the neck-bracing strap, and the girth-bracing band are made of laminated neoprene.

7. The pet harness with a weighted thermal insert as claimed in claim 1 comprising:
the at least one weighted thermal insert comprising an insert fabric enclosure and a plurality of heat-sinking beads;
the plurality of heat-sinking beads being positioned within the insert fabric enclosure; and
the plurality of heat-sinking beads being evenly distributed throughout the insert fabric enclosure.

8. The pet harness with a weighted thermal insert as claimed in claim 7 comprising:
the at least one weighted thermal insert further comprising a plurality of aromatherapeutic beads;
the plurality of aromatherapeutic beads being positioned within the insert fabric enclosure; and
the plurality of aromatherapeutic beads being heterogeneously mixed into the plurality of heat-sinking beads.

9. The pet harness with a weighted thermal insert as claimed in claim 1 comprising:
a first piece of light-reflective stitching;
a second piece of light-reflective stitching;
a third piece of light-reflective stitching;
the first band end being connected adjacent to the first lateral edge by the first piece of light-reflective stitching;
the second band end being attached adjacent to the second lateral edge by the second piece of light-reflective stitching; and
the third piece of light-reflective stitching being perimetrically integrated into the neck-bracing strap, the girth-bracing band, and the back-bracing pad.

10. The pet harness with a weighted thermal insert as claimed in claim 1 comprising:
the girth-bracing band further comprising a first lengthwise edge and a second lengthwise edge;
the first lengthwise edge being a convex edge;
the second lengthwise edge being a concave edge;
the first lengthwise edge being oriented at an obtuse angle with the cranial edge;
the first lengthwise edge being positioned coincident with the cranial edge;
the first lengthwise edge being oriented away from the neck-bracing strap; and
the second lengthwise edge being positioned coincident with the caudal edge.

11. The pet harness with a weighted thermal insert as claimed in claim 1 comprising:
a band fastener;
the girth-bracing band further comprising a first band section and a second band section;
the first band section and the second band section each comprising a free section end and a fixed section end;
the fixed section end of the first band section being positioned coincident to the first band end;
the fixed section end of the second band section being positioned coincident to the second band end; and
the free section end of the first band section being connected to the free section end of the second band section by the band fastener.

12. The pet harness with a weighted thermal insert as claimed in claim 11 comprising:
the band fastener comprising a first band fastener piece and a second band fastener piece;
the first band fastener piece being mounted onto the first band section, adjacent to the free second end of the first band section;
the second band fastener piece being mounted onto the second band section, adjacent to the free section end of the second band section; and
the first band fastener piece being engaged with the second band fastener piece.

13. The pet harness with a weighted thermal insert as claimed in claim 1 comprising:
the neck-bracing strap further comprising a first strap member, a second strap member, and a strap ring;
the first strap member being positioned coincident to the first strap end;
the second strap member being positioned coincident to the second strap end;
the second strap member being looped through the strap ring, offset from the second strap end; and
the first strap member being looped through the strap ring, offset from the first strap end.

14. The pet harness with a weighted thermal insert as claimed in claim 13 comprising:
a first strap fastener;
the first strap fastener comprising a first proximal strap fastener piece and a first distal strap fastener piece;
the first proximal strap fastener piece being mounted onto the first strap member, adjacent to the first strap end;
the first distal strap fastener piece being mounted onto the first strap member, offset from the first strap end; and
the first distal strap fastener piece being engaged with the first proximal strap fastener piece.

15. The pet harness with a weighted thermal insert as claimed in claim 13 comprising:
a second strap fastener;
the second strap fastener comprising a second proximal strap fastener piece and a second distal strap fastener piece;
the second proximal strap fastener piece being mounted onto the second strap member, adjacent to the second strap end;
the second distal strap fastener piece being mounted onto the second strap member, offset from the second strap end; and
the second distal strap fastener piece being engaged with the second proximal strap fastener piece.

16. The pet harness with a weighted thermal insert as claimed in claim 1 comprising:
at least one leash-attachment eyelet;
the at least one leash-attachment eyelet being positioned adjacent to the cranial edge;
the at least one leash-attachment eyelet being centrally positioned along the cranial edge; and
the at least one leash-attachment eyelet being externally mounted onto the back-bracing pad.

17. The pet harness with a weighted thermal insert as claimed in claim 16 comprising:
a handle strap;
the handle strap comprising a first handle end and a second handle end;
the handle strap being looped through the at least one leash-attachment eyelet;
the first handle end being connected onto the back-bracing pad, adjacent to the cranial edge; and
the second handle end being connected onto the back-bracing pad, adjacent to the caudal edge.

18. The pet harness with a weighted thermal insert as claimed in claim 1 comprising:
the back-bracing pad further comprising a pad outer layer and a pad inner layer;
the pad outer layer being a thermal-insulative fabric;
the pad inner layer being a moisture-wicking fabric;
the pad outer layer being coextensive with the pad inner layer; and
the pad outer layer being perimetrically connected to the pad inner layer.

19. The pet harness with a weighted thermal insert as claimed in claim 18 comprising:
the insert pocket being integrated in between the pad outer layer and the pad inner layer.
